(19) United States
(12) Patent Application Publication
(10) Pub. No.: US 2007/0298273 A1
(43) Pub. Date: Dec. 27, 2007

(54) Multilayer shrink films having a core layer of EVA/ionomer blend

(75) Inventors: Robert Wayne Thies, Oshkosh, WI (US); Scott Allan Idlas, Appleton, WI (US)

Correspondence Address: BEMIS COMPANY, INC., 2200 BADGER AVENUE, OSHKOSH, WI, 54904, US

(73) Assignee: Bemis Clysar, Inc.

(21) Appl. No.: 11/475,762

(22) Filed: Jun. 27, 2006

(51) Int. Cl. B32B 27/08; B32B 27/30; B32B 27/32

(52) U.S. Cl. 428/516; 428/523; 428/522; 428/910

(57) ABSTRACT

Heat shrinkable multilayer packaging films comprising at least one core of a blend of at least 50% by weight of an ethylene unsaturated-ester copolymer and a material selected from the group consisting of ionomers, ethylene/acid copolymers and terpolymers, or blends, and two outer-film layers comprising a polyolefin. The invention includes films and packaging articles.

### TECHNICAL FIELD

This invention relates to heat-shrinkable, packaging films; and in particular, this invention relates to a multilayer shrink films having desirable coefficient of friction characteristics while providing good heat shrink, shrink tension and optical properties.

### BACKGROUND OF THE INVENTION

The distinguishing characteristic of heat-shrinkable films is their ability upon exposure to some level of heat to shrink, or if restrained, create shrink tension within the film. This ability of the film to shrink arises from the orientation of that film during manufacture. The films are usually heated to their orientation temperature range which varies with the different polymers but is usually above room temperature and below the polymer's melting temperature. The film is then stretched in the cross or transverse direction and in the longitudinal or machine direction to orient it. After being stretched, the film is rapidly cooled to quench it, thus freezing the molecules of the film in their oriented state. Upon heating, the orientation stresses are relaxed and the film will begin to shrink back to its original, un-oriented dimension.

Heat-shrinkable film characteristics play an important role in the selection of a particular film and may differ for each type of packaging application and for each packager. Consideration must be given to the product's size, weight, shape, rigidity, number of product components other packaging materials which may be used along with the film and the type of packaging equipment. In some cases, it is desirable that the shrink film have lower shrink force or tension than is conventionally experienced without sacrificing the amount of shrink. For example, where fragile products are to be packaged, i.e., for retail display and the like, excessive shrink force may deform or distort the shape of the product during the packaging process, thus making the product appear unattractive to the consumer. Retail display products may include, but are not limited to, such items as toys, games, sporting goods, stationary, greeting cards, hardware and household products, office supplies and forms, foods, industrial parts and the like.

A drawback to some heat-shrinkable films is their tendency to stick to the surface of itself or production equipment during a production process, making the manufacture of packaging articles and packaged products more labor extensive and less efficient. It would be advantageous to use shrink films having lower coefficient of friction during these manufacturing processes, and particularly for use on high speed automatic and semi-automatic shrink wrapping equipment in order to avoid or eliminate these problems.

What is needed are heat-shrinkable packaging products that have enhanced machinability or processability, i.e., low coefficient of friction, while also providing good orientability, low shrink tension and excellent optical properties.

### BRIEF SUMMARY OF THE INVENTION

It has been discovered that biaxially-oriented multilayer thermoplastic packaging films having a desirable combination of physical characteristics such as heat shrinkage, shrink tension, coefficient of friction and optical characteristics have been achieved by the biaxially-oriented multilayer thermoplastic packaging films of the present invention. These multilayer films have two “outer-film” layer each comprising a polyolefin and at least one “core” layer that includes a blend of an ethylene unsaturated-ester copolymer and an ionomers, ethylene/acid copolymers, terpolymers, or blends thereof.

In a first embodiment, biaxially-oriented multilayer thermoplastic films are provided that comprise a core layer containing a blend of at least 50% by weight of a first material comprising an ethylene unsaturated-ester copolymer and a second material selected from the group consisting of ionomers, ethylene/acid copolymers and terpolymers, or blends thereof, two outer-film layers each comprising a polyolefin such that the film has an unrestrained linear thermal shrinkage value of at least 20% in both machine and transverse directions at 100° C., and preferably, at least 30% in both machine and transverse directions at 100° C. Advantageously, the films have a coefficient of friction of less than 0.5, preferably, less than 0.25 and more preferably, less than 0.10. Preferably, the core layer has a relative thickness of between 50 to 95% of the total thickness of the multilayer films. The films of the present invention have a shrink tension of 300 psi or less, a clarity value of at least 85%, and a haze value of less than 4%. Preferably, the core layer includes a slip agent in an amount of between 0.2 to 1.0% by weight, and more preferably, the core layer contains an amide slip agent in an amount of between 0.2 to 1.0% by weight. Preferably, the films are fabricated by coextrusion and more preferably, blown film coextrusion.

In another embodiment, biaxially-oriented multilayer films are provided that include a core layer which further comprises at least 20% by weight relative to said core layer of a second material selected from the group consisting of ionomers, ethylene/acid copolymers and terpolymers, or blends thereof, and two outer-film layers each comprising a blend of a linear low-density polyethylene, a very low-density polyethylene or an ultra low-density polyethylene copolymer and a low-density polyethylene.

In still another embodiment, biaxially-oriented multilayer films are provided that comprise a core layer which has a thickness of at least 50% of the total thickness of the film and still further includes between 0.2 to 1.0% by weight of an amide slip agent. This embodiment further includes a first intermediate layer comprising a polyolefin and positioned between a first outer-film layer and the core layer, and a second intermediate layer comprising a polyolefin and positioned between a second outer-film layer and the core layer. Films of this embodiment still further have a coefficient of friction of less than 0.25 and preferably, less than 0.10.

In still yet another embodiment of the present invention, packaging articles are provided.

### BRIEF DESCRIPTION OF SEVERAL VIEWS OF THE DRAWINGS

FIG. 1 shows a cross sectional schematic of a first exemplary multilayer film.

FIG. 2 shows a cross sectional schematic of a second exemplary multilayer film.

FIG. 3 shows a cross sectional schematic of a comparative exemplary multilayer film.

### DETAILED DESCRIPTION OF THE INVENTION

### Definitions

In discussing plastic packaging film, various polymer acronyms are used herein and they are listed below. Also, in referring to blends of polymers a colon (:) will be used to indicate that the components to the left and right of the colon are blended. In referring to film structure, a slash “/” will be used to indicate that components to the left and right of the slash are in different layers and the relative position of components in layers may be so indicated by use of the slash to indicate film layer boundaries.

A “polymer” as used herein, refers to the product of a polymerization reaction, and is inclusive of homopolymers, copolymers, terpolymers, etc. In general, the layers of a film can consist essentially of a single polymer, or can have still additional polymers together therewith, i.e., blended therewith.

A “copolymer” as used herein, refers to polymers formed by the polymerization of reaction of at least two different monomers. For example, the term “copolymer” includes the co-polymerization reaction product of ethylene and an α-olefin, such as 1-hexene. The term “copolymer” is also inclusive of, for example, the co-polymerization of a mixture of ethylene, propylene, 1-propene, 1-butene, 1-hexene, and 1-octene. As used herein, a copolymer identified in terms of a plurality of monomers, e.g., “propylene ethylene copolymer”, refers to a copolymer in which either monomer may copolymerize in a higher weight or molar percent than the other monomer or monomers. However, the first listed monomer preferably polymerizes in a higher weight percent than the second listed monomer.

A “core layer,” as used herein, refers to an “inner layer” positioned between and in contact with at least two other layers of a multilayer film. An “inner layer” refers to any film layer having both of its principal surfaces directly adhered to two other layers of the film.

An “outer layer,” as used herein, refers to any film layer of a multilayer film having less than two of its principal surfaces directly adhered to another layer of the film. An outer layer may be an interior or exterior film layer and function as a sealant layer or an abuse-resistant layer. A “sealant layer” generally refers to an outer layer or layers, involved in the sealing of the film: to itself, to another film layer of the same film or another film; and/or to another article which is not a film, e.g., a tray.

“Polyolefin” is used herein broadly to include polymers such as polyethylene, ethylene-alpha olefin copolymers (EAO), polypropylene, polybutene, and ethylene copolymers having a majority amount by weight of ethylene polymerized with a lesser amount of a comonomer such as vinyl acetate, and other polymeric resins falling in the “olefin” family classification. Polyolefins may be made by a variety of processes well known in the art including batch and continuous processes using single, staged or sequential reactors, slurry, solution and fluidized bed processes and one or more catalysts including for example, heterogeneous and homogeneous systems and Ziegler, Phillips, metallocene, single site and constrained geometry catalysts to produce polymers having different combinations of properties. Such polymers may be highly branched or substantially linear and the branching, dispersity and average molecular weight and may vary depending upon the parameters and processes chosen for their manufacture in accordance with the teachings of the polymer arts.

“Polyethylene” is the name for a polymer whose basic structure is characterized by the chain —(CH₂—CH₂—)ₙ. Polyethylene homopolymer is generally described as being a solid which has a partially amorphous phase and partially crystalline phase with a density of between 0.915 to 0.970 g/cm³. The relative crystallinity of polyethylene is known to affect its physical properties. The amorphous phase imparts flexibility and high impact strength while the crystalline phase imparts a high softening temperature and rigidity. Unsubstituted polyethylene is generally referred to as high density homopolymer and has a crystallinity of 70 to 90 percent with a density between about 0.96 to 0.97 g/cm³. Most commercially utilized polyethylenes are not unsubstituted homopolymer but instead have C₂-C₈ alkyl groups attached to the basic chain. These substituted polyethylenes are also known as branched chain polyethylenes. Also, commercially available polyethylenes frequently include other substitutent groups produced by copolymerization. Branching with alkyl groups generally reduces crystallinity, density and melting point. The density of polyethylene is recognized as being closely connected to the crystallinity. The physical properties of commercially available polyethylenes are also affected by average molecular weight and molecular weight distribution, branching length and type of substitutents. People skilled in the art generally refer to several broad categories of polymers and copolymers as “polyethylene.” Placement of a particular polymer into one of these categories of “polyethylene” is frequently based upon the density of the “polyethylene” and often by additional reference to the process by which it was made since the process often determines the degree of branching, crystallinity and density. In general, the nomenclature used is nonspecific to a compound but refers instead to a range of compositions. This range often includes both homopolymers and copolymers.

For example, “high density” polyethylene (HDPE) is ordinarily used in the art to refer to both (a) homopolymers of densities between about 0.960 to 0.970 g/cm³ and (b) copolymers of ethylene and an alpha-olefin (usually 1-butene or 1-hexene) which have densities between 0.940 and 0.958 g/cm³. HDPE includes polymers made with Ziegler or Phillips type catalysts and is also said to include high molecular weight “polyethylenes.” In contrast to HDPE, whose polymer chain has some branching, are “ultra high molecular weight polyethylenes” which are essentially unbranched specialty polymers having a much higher molecular weight than the high molecular weight HDPE.

Hereinafter, the term “polyethylene” will be used (unless indicated otherwise) to refer to ethylene homopolymers as well as copolymers of ethylene with alpha-olefins and the term will be used without regard to the presence or absence of substitutent branch groups.

Another broad grouping of polyethylene is “high pressure, low density polyethylene” (LDPE). LDPE is used to denominate branched homopolymers having densities between 0.915 and 0.930 g/cm³. LDPEs typically contain long branches off the main chain (often termed “backbone”) with alkyl substitutents of 2 to 8 carbon atoms.

“Linear Low Density Polyethylenes” (LLDPEs) are copolymers of ethylene with alpha-olefins having densities from 0.915 to 0.940 g/cm³. The alpha-olefin utilized is usually 1-butene, 1-hexene, or 1-octene and Ziegler-type catalysts are usually employed (although Phillips catalysts are also used to produce LLDPE having densities at the higher end of the range, and metallocene and other types of catalysts are also employed to produce other well known variations of LLDPEs).

“Ethylene α-olefin copolymers” (EAOs) are copolymers having an ethylene as a major component copolymerized with one or more alpha olefins such as octene-1, hexene-1, or butene-1 as a minor component. EAOs include polymers known as LLDPE, VLDPE, ULDPE, and plastomers and may be made using a variety of processes and catalysts including metallocene, single-site and constrained geometry catalysts as well as Ziegler-Natta and Phillips catalysts.

“Ultra Low Density Polyethylenes” (ULDPEs) which are also called Very Low Density Polyethylene (VLDPE) comprise copolymers of ethylene with alpha-olefins, usually 1-butene, 1-hexene or 1-octene and are recognized by those skilled in the art as having a high degree of linearity of structure with short branching rather than the long side branches characteristic of LDPE. However, VLDPEs have lower densities than LLDPEs. The densities of VLDPEs are recognized by those skilled in the art to range between 0.860 and 0.915 g/cm³. A process for making VLDPEs is described in European Patent Document publication number 120,503 whose text and drawing are hereby incorporated by reference into the present document. Sometimes VLDPEs having a density less than 0.900 g/cm³ are referred to as “plastomers”.

“Ethylene unsaturated-ester copolymers” refer to copolymers having an ethylene linkage between comonomer units and resulting from the copolymerization of an ethylene comonomer and an unsaturated-ester comonomer. As used herein, the phrase “unsaturated-ester comonomer” refers to comonomer units which may be represented by the following general chemical formulae: (A) CH₂CROC(O)CH₃ where R═H or an alkyl group which includes, for example, but is not limited to, methyl, ethyl, propyl, and butyl; (B) CH₂C(R)C(O)OR where R═H or an alkyl group which includes, for example, but is not limited to, methyl, ethyl, propyl, butyl, 2-ethylhexyl and R=an alkyl group which includes, but is not limited to, methyl, ethyl, propyl, and butyl. Preferably, the ethylene unsaturated-ester copolymer is selected from the group consisting of ethylene vinyl acetate copolymer, ethylene butyl acetate copolymer, ethylene methyl acetate copolymer, ethylene ethyl acetate copolymer, and blends thereof.

“Ionomers” and “ethylene acid copolymers and terpolymers” each refer to ionic copolymers and terpolymers formed from an olefin and an ethylenically unsaturated monocarboxylic acid having the carboxylic acid moieties partially or completely neutralized by a metal ion. Suitable metal ions may include, but are not limited to, sodium, potassium, lithium cesium, nickel, and preferably zinc. Suitable carboxylic acid comonomers may include, but are not limited to, ethylene acid copolymers, such as, ethylene methacrylic acid, methylene succinic acid, maleic anhydride, vinyl acetate methacrylic acid, methyl methacrylate methacrylic acid, styrene methacrylic acid and combinations thereof. Useful ionomer ethylene/acid copolymer and terpolymer resins may include an olefinic content of at least 50% (mol) based upon the copolymer and a carboxylic acid content of between 5-25% (mol) based upon the copolymer. Useful ionomers are also described in U.S. Pat. No. 3,355,319 to Rees, which is incorporated herein by reference in its entirety.

The term “haze” as used herein refers to the percentage of transmitted light that, in passing through a film specimen, deviates from the incident beam by forward scattering. Haze may also be defined as a measure of the intensity of the transmitted light that is scattered more than 2.5° (presented as a percentage of the total transmitted light). Haze may appear as a milky, smoky, hazy field when looking through a film specimen. Low values are a measurement of low “haze”.

As used herein, the term “gloss” refers to specular gloss and is the relative luminous fractional reflection of a specimen film at a specular direction of 45° or 60°. Gloss may also be a measurement of the proportion of light striking a surface at a given angle, i.e., 45° and 60°, which is reflected at an equal and opposite angle. In general, gloss correlates with the shininess or sparkle of the surface of a film. Therefore, a film surface which has no surface defects, i.e., a mirror, will have a gloss value between 75% to 100%, preferably, at least 100% and more preferably, greater than 100%, as compared to a film with surface defects, i.e., matte finish, which has a gloss value of between 0% to 74%.

“Clarity” refers to the distinctness with which an object appears when viewed through a film and may be a measure of the light that is scattered less than 0.1° when passing through a film. Clarity may be indicated as a percentage of transparency of a film specimen.

A “packaging article” as used herein, refers to an object of manufacture which can be in the form of a web, e.g., multilayer films or sheets, containers, e.g., bags, shrink bags, pouches, casings, trays, lidded trays, overwrapped trays, form shrink packages, vacuum skin packages, flow wrap packages, thermoformed packages, packaging inserts or combinations thereof. It will be appreciated by those skilled in the art that, in accordance with the present invention, packaging articles may include flexible, rigid, or semi-rigid materials

### Outer-Film Layers

The multilayer films of the present invention comprise two outer layers. In some embodiments of the invention, at least one outer-film layer is the exterior surface of the film and should enhance optical properties of the film and may, preferably have high gloss. This layer may also withstand contact with sharp objects and provide abrasion resistance, and for these reasons, may function as an abuse-resistant layer. This outer abuse-resistant layer may or may not also be used as a heat sealable layer. As the exterior surface of the film, this layer most often is also the exterior surface of any package, bag, pouch, tray or other container made from the inventive film, and is therefore subject to handling and abuse, e.g., from equipment during packaging, and from rubbing against other packages and shipping containers and storage shelves during transport and storage. This contact causes abrasive forces, stresses and pressures which may abrade away the film causing defects to printing, diminished optical characteristics or even punctures or breaches in the integrity of the package. Therefore one of the outer layers may be made from materials chosen to be resistant to abrasive and puncture forces and other stresses and abuse which the packaging may encounter during use. The exterior surface outer layer should be easy to machine (i.e., be easy to feed through and be manipulated by machines, e.g., for conveying, packaging, printing or as part of the web or bag manufacturing process). It should also facilitate stretch orientation where a high shrinkage film is desired. Suitable stiffness, flexibility, flex crack resistance, modulus, tensile strength, coefficient of friction, printability, and optical properties are also frequently designed into exterior layers by suitable choice of materials. This layer may also be chosen to have characteristics suitable for creating desired heat seals which may be heat resistance to burn through, e.g., by impulse sealers or may be used as a heat sealing surface in certain package embodiments, e.g., using overlap seals. Suitable materials for use in the outer layers of the multilayer films of the present invention include polyolefins, preferably, polyethylenes and more preferably, a blend of linear low-density polyethylene, very low-density polyethylene or ultra low-density polyethylene and low-density polyethylene, as described herein.

### Core Layer

It is desirable that the multilayer films of the present invention include at least one core layer which provides the desired combination of the performance properties sought, e.g., with respect to heat shrinkage, orientability, processability, low shrink tension, delamination resistance, and optical properties of the multilayer film. To achieve this purpose, suitable core layers comprise a combination of components including a first material of at least 50% by weight relative to the total weight of the core layer of an ethylene unsaturated-ester copolymer and a second material selected from the group consisting of ionomers, ethylene acid copolymers or terpolymers or blends thereof. Preferably, the core layer thicknesses in multilayer films are at least 30%, frequently more than 50%, and more frequently from 50 to 95% of the total film thickness. Multilayer films of the present invention may include one or more core layers.

### Intermediate Layers

An intermediate layer is any layer between the outer layers and the core layer and may include tie layers, oxygen barrier layers or layers having functional attributes useful for the film structure or its intended uses. Intermediate layers may be used to improve, impart or otherwise modify a multitude of characteristics: e.g., printability for trap printed structures, shrinkability, orientability, processability, machinability, tensile properties, drape, flexibility, stiffness, modulus, designed delamination, easy opening features, tear properties, strength, elongation, optical, moisture barrier, oxygen or other gas barrier, radiation selection or barrier, e.g., to ultraviolet wavelengths, etc.

### Tie Layers

In addition to the outer layers, intermediate and core layers, a multilayer packaging film can further comprise one or more adhesive layers, also known in the art as “tie layers,” which can be selected to promote the adherence of adjacent layers to one another in a multilayer web and prevent undesirable delamination. A multifunctional layer is preferably formulated to aid in the adherence of one layer to another layer without the need of using separate adhesives by virtue of the compatibility of the materials in that layer to the first and second layers. In some embodiments, adhesive layers comprise materials found in both the first and second layers. The adhesive layer may suitably be less than 10% and preferably between 2% and 10% of the overall thickness of the multilayer film. Adhesive resins are often more expensive than other polymers so the tie layer thickness is usually kept to a minimum consistent with the desired effect. In one embodiment, a multilayer web comprises a multilayer structure comprising a first adhesive layer positioned between and in direct contact with the exterior layer and a core layer; and preferably and optionally has a second tie layer between and in direct contact with the same core layer and the interior layer to produce a five layer web. Multilayer films can comprise any suitable number of tie or adhesive layers of any suitable composition. Various adhesive layers are formulated and positioned to provide a desired level of adhesive between specific layers of the film according to the composition of the layers contacted by the tie layers.

### Slip Agent

A “slip agent” as used herein refers to any additive incorporated into a one or more film layers which can modify the surface properties of a multilayer film and, preferably, reduce the film to film friction, e.g., on a roll, and the friction between the film and other surfaces with which they come into contact with, e.g., production equipment. Slip agents therefore may enhance packaging machine operations due to reduced coefficient of friction values and/or facilitate increased line speed in the manufacturing process. Examples slip additives suitable for use in the present invention may include, but are not limited to, one or more of the following: fluoroelastomers, silicates and amides slip, such as stearamides, oleamides, and erucamides. Examples of slip and antiblock agents which may be useful in the multilayer films are known to those skilled in the art and include clay or hydrated aluminum silicates, talc or hydrated magnesium silicates, amorphous silicas, calcium carbonate, calcium phosphate, types of glass, e.g., soda-lime-borosilicate glass, and various ceramics, i.e., for example, silica-alumina ceramic and alkali alumino silicate ceramic (“Zeeospheres”) available from 3M, Minneapolis, Minn., U.S.A.). Still further examples of slip or antiblock agents include polymethacrylate (EPOSTAR® MA available from Nippon Shokubai Company, Ltd., Tokyo, Japan), polymethylsilssesquioxane (TOSPEARL® available from General Electric Company, Fairfield, Conn., U.S.A.), benzoguanamine formaldehyde, polycarbonate, polyamide, polyester, TEFLON® powder, ultra-high molecular weight polyethylene powder, natural and synthetic starch, and combinations thereof. Examples of glass and ceramic slip or antiblock agents are described in U.S. Patent Application Publication No. 2006/0068183 to Nelson et al. which is hereby incorporated by reference.

### Optional Additives to Layers

In addition to the slip agents described herein, various additives may also be included in the polymers utilized in one or more of the exterior, interior and intermediate or tie layers of packaging films. For example, a layer may be coated with an anti-block powder. Also, conventional anti-oxidants, antiblock additives, polymeric plasticizers, acid, moisture or gas (such as oxygen) scavengers, colorants, dyes, pigments, may be added to one or more film layers of the film or it may be free from such added ingredients. If the exterior layer is corona treated, preferably no slip agent will be used, but it will contain or be coated with an anti-block powder or agent such as silica or starch. Processing aides are typically used in amounts less than 10%, less than 7% and preferably less than 5% of the layer weight. Preferred films may also provide a beneficial combination of one or more or all of the properties including low haze, high gloss, high shrinkage values at 100° C., low shrink tension, low coefficient of friction, good machinability, and good mechanical strength.

### Film Thicknesses

Preferably, a flexible film has a total thickness of less than about 10 mil, more preferably the film has a total thickness of from about 0.25 to 10 mil (6.2-254 microns (μ)). Advantageously many embodiments may have a thickness from about 0.25 to 5.0 mil, with certain typical embodiments being from about 0.5 to 2.0 mil. For example, multilayer films can have any suitable thicknesses, including 0.25, 0.50, 1, 2, 3, 4, 5, 6, 7, 8, 9, or 10 mil, or any increment of 0.1 or 0.01 mil therebetween.

### Methods of Manufacture

The inventive multilayer films may be made by conventional processes which are modified to provide biaxial stretched heat-shrinkable films. These processes to produce flexible films may include cast or blown film processes. Descriptions of suitable film manufacturing and lamination processes are disclosed in, e.g., U.S. Pat. No. 3,311,679 (E. J. Moore) of which is incorporated herein by reference in its entirety.

Various manufacturing methods may be used as will be apparent to those skilled in the art in view of the present teaching. For example, U.S. Pat. No. 4,448,792 (Schirmer) discloses a method comprising the steps of coextrusion, biaxial orientation and irradiation, and U.S. Pat. No. 3,741,253 (Brax et al.) discloses a method of extrusion, irradiation, extrusion lamination/coating and biaxial orientation, and both patents are hereby incorporated by reference in their entireties.

In a preferred process for making films, the resins and any additives are introduced to an extruder (generally one extruder per layer) where the resins are melt plastified by heating and then are transferred to an extrusion (or coextrusion) die for formation into a tube. Extruder and die temperatures will generally depend upon the particular resin or resin containing mixtures being processed and suitable temperature ranges for commercially available resins are generally known in the art, or are provided in technical bulletins made available by resin manufacturers. Processing temperatures may vary depending upon other process parameters chosen. However, variations are expected which may depend upon such factors as variation of polymer resin selection, use of other resins, e.g., by blending or in separate layers in the multilayer web, the manufacturing process used and particular equipment and other process parameters utilized. Actual process parameters including process temperatures are expected to be set by one skilled in the art without undue experimentation in view of the present disclosure.

As generally recognized in the art, resin properties may be further modified by blending two or more resins together and it is contemplated that various resins including, e.g., homopolymers and copolymers may comprise or be blended into individual layers of the multilayer web or added as additional layers, such resins include polyolefins such as ethylene-unsaturated ester copolymer resins, especially vinyl ester copolymers such as EVAs, or other ester polymers, very low density polyethylene (VLDPE), linear low density polyethylene (LLDPE), low density polyethylene (LDPE), high density polyethylene (HDPE), ionomers, polypropylenes, or blends thereof. Other polymers that may be included as separate layers or in combination include polyamides such as nylon, PVDC, EVOH, and PET. These resins and others may be mixed by well known methods using commercially available tumblers, mixers or blenders.

Also, if desired, well known additives such as anti-oxidants, processing aids, slip agents, antiblocking and antifogging agents, pigments, etc., and mixtures thereof may be incorporated into the web. For example, the myoglobin blooming agent containing layer and/or other layers may further comprise an antioxidant, a slip agent, an antiblock agent, a colorant, a color enhancer, a flavorant, an odorant, an organoleptic agent, a coefficient of friction modifying agent, a lubricant, a surfactant, an encapsulating agent, an oxygen scavenger, a pH modiflying agent, a film forming agent, an emulsifier, a polyphosphate, a humectant, a drying agent, an antimicrobial agent, a chelating agent, a binder, a starch, a polysaccharide, a stabilizer, a buffer, a phospholipid, an oil, a fat, a protein, a polysaccharide, a transfer agent, or a combination thereof.

Various polymer modifiers may be incorporated for the purpose of improving toughness, orientability, extensibility and/or other properties of the web. Other modifiers which may be added include modifiers which improve low temperature toughness or impact strength and modifiers which reduce modulus or stiffness. Exemplary modifiers include styrene-butadiene, styrene-isoprene, and ethylene-propylene copolymers.

The term “biaxially-oriented” as used herein in accordance with the present invention, refers to films which have been elongated or “stretch oriented” in two directions at elevated temperatures followed by being “set” in the elongated configuration by cooling the material while substantially retaining the elongated dimensions. This combination of elongation at elevated temperature followed by cooling causes an alignment of the polymer chains to a more parallel configuration, thereby improving the mechanical properties of the film. Upon subsequently heating unrestrained, unannealed, biaxially-oriented polymer-containing film to its orientation temperature, heat-shrinkage is produced almost to the original dimensions. Stretch orientation may be accomplished by various known methods, e.g., machine direction (MD) orientation is preferably accomplished with the use of sets of nip rolls rotating at different speeds to stretch or draw the film, sheet or tube in the machine direction thereby causing machine direction elongation which is set by cooling. Other methods include tentering which is commonly employed to orient sheets, or the well-known trapped bubble or double bubble technique for orienting tubes as for example described in U.S. Pat. No. 3,456,044 (Pahlke) which is hereby incorporated by reference in its entirety. The preferred method of manufacturing the present invention includes the bubble coextrusion technique, where an extruded primary tube leaving a tubular extrusion die is cooled and then preferably oriented by reheating and inflating to form an expanded secondary bubble, which is again cooled and collapsed. This collapsed stretched film may be wound on a reel as a tube or slit into sheets or webs and wound, or it may be further processed, e.g., by annealing or irradiation as described below.

The general annealing process by which biaxially stretched heat-shrinkable films are heated under controlled tension to reduce or eliminate shrinkage values is well known in the art. If desired, films may be annealed to produce lower shrinkage values as desired for the particular temperature. Accordingly, using an annealing process, heat shrinkable films may be made into non-shrink films suitable for use in certain embodiments as described herein.

Optionally, films of the present invention may be subject to a variety of irradiative treatments. In the irradiation process, the film is subjected to an energetic radiation treatment, such as corona discharge, plasma, flame, ultraviolet, X-ray, gamma ray, beta ray, and high energy electron treatment. These irradiative treatments may be performed for a variety of reasons including, e.g., modifying surface characteristics to improve surface adhesion to a variety of substances such as meat or printing ink, or to improve internal layer adhesion to ameliorate intralayer adhesion and avoid undesirable delamination. An important known use of irradiation is to induce cross-linking between molecules of the irradiated material. The irradiation of polymeric webs to induce favorable properties such as crosslinking is well known in the art and is disclosed in U.S. Pat. Nos. 4,737,391 (Lustig et al) and 4,064,296 (Bornstein et. al.), which are hereby incorporated by reference in their entireties. Bornstein et al. disclose the use of ionizing radiation for crosslinking the polymer present in the film. In some preferred embodiments, it is preferred to crosslink the entire film to broaden the heat sealing range. This is preferably done by irradiation with an electron beam at dosage levels of at least about 2 megarads (MR) and preferably in the range of 3 to 8 MR, although higher dosages may be employed. Irradiation may be done on the primary tube, with or without additional layers being coated thereon, or after biaxial orientation. The latter, called post-irradiation, is described in U.S. Pat. No. 4,737,391 (Lustig et al.). An advantage of post-irradiation is that a relatively thin film is treated instead of the relatively thick primary tube, thereby reducing the power requirement for a given treatment level.

Alternatively, crosslinking may be achieved by addition of a chemical crosslinking agent or by use of irradiation in combination with a crosslinking modifier added to one or more of the layers, as for example described in U.S. Pat. No. 5,055,328 (Evert et al.).

Shrinkage values are defined to be values which may be obtained by measuring unrestrained shrink of a 10.0 cm square sample immersed in water at 90° C. (or the indicated temperature if different) for five seconds. Four test specimens are cut from a given sample of the web to be tested. The specimens are cut into squares of 10.0 cm length in the machine direction (MD) by 10.0 cm length in the transverse direction (TD). Each specimen is completely immersed for 5 seconds in a 90° C. (or the indicated temperature if different) water bath. The specimen is then removed from the bath and the distance between the ends of the shrunken specimen is measured for both the machine direction (MD) and transverse direction (TD). The difference in the measured distance for the shrunken specimen and the original 10.0 cm side is multiplied by ten to obtain the percent of shrinkage for the specimen in each direction. The shrinkage of four specimens is averaged for the MD shrinkage value of the given web sample, and the shrinkage for the four specimens is averaged for the TD shrinkage value. As used herein the term “heat-shrinkable web” may refer to a web having an unrestrained shrinkage value of at least 10% in at least one direction at 90° C. The term “total free shrink” refers to the sum of the shrink percentages in the MD and TD directions.

The shrink force of a film is that force required to prevent shrinkage of the film and is determined from web samples taken from each web. Four film samples are cut 1″ (2.54 cm) wide by 7″ (17.8 cm) long in the machine direction and 1″ (2.54 cm) wide by 7″ (17.8 cm) long in the traverse direction. The average thickness of the film samples is determined and recorded. Each film sample is then secured between the two clamps spaced 10 cm apart. One clamp is in a fixed position and the other is connected to a strain gauge transducer. The secured film sample and clamps is then immersed in a silicone oil bath maintained at a constant, elevated temperature for a period of five seconds. During this time, the force in grams manifested by the shrink tension of the film at the elevated temperature is recorded. At the end of this time, the film sample is removed from the bath and allowed to cool to room temperature whereupon the force in grams at room temperature is also recorded. The shrink force for the film sample is then determined from the following equation wherein the results are obtained in grams force per mil of film thickness (g/mil). Shrink Force (gF/mil)=F/T wherein F is the force in grams and T is the average thickness of the film samples in mil.

Shrinkage values, shrink force, and free shrink are measured by the methods described above or tests similar thereto, unless otherwise specified. Other useful tests are provided by the following references, which are incorporated herein in their entirety: U.S. Pat. Nos. 6,869,686; 6,777,046 and 5,759,648.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. In referring to film structures, a slash “/” will be used to indicate that components to the left and right of the slash are in different layers and the relative position of components in layers may be so indicated by use of the slash to indicate film layer boundaries.

### EXAMPLES

### Example 1

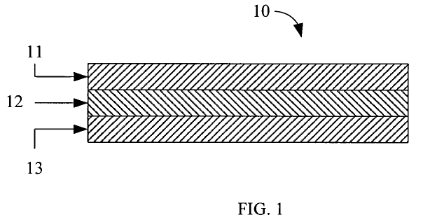

Referring now to FIG. 1, Example 1 is illustrated by film 10 and represents one example of a three-layer embodiment of the present invention. Film 10 may be prepared by a bubble coextrusion method as described herein. Film 10 may include the following film configuration, layer composition and layer thickness (represented in brackets [ ] as percent thickness relative to the overall thickness of the film) as illustrated in Table 1:

TABLE 1
Film 10

| Layer No./Type | Layer Composition |
|---|---|
| 11 Outer-film Abuse | ULDPE:LDPE:additives [25.0%] |
| 12 Core | EVA:ionomer:slip agent [50.0%] |
| 13 Outer-film Sealant | ULDPE:LDPE:additives [25.0%] |

Film 10 in FIG. 1 is depicted as having a first layer 11 which is a first outer-film layer which may serve as an abuse layer, a second layer 12 which may serve as a core layer, a third layer 13 which is the second outer-film layer which may function as a sealant layer.

Layers 11 and 13 of film 10 may each comprise a blend of 68.0% by weight of ultra low density polyethylene (ULDPE):21.5% by weight of low density polyethylene (LDPE): 10.5% by weight of additives. The ULDPE may include an ethylene/octene polyethylene copolymer having a melting point of 123° C., a melt index of 1.0 g/10 min, a density of 0.9120 g/cm³, and a Vicat softening point of 93° C. An example of a commercially available ethylene/octene polyethylene copolymer which exhibits the desired characteristics as described above is sold under the trademark ATTANE® 4201G by The Dow Chemical Company, Midland, Mich., U.S.A. The LDPE may be characterized as having a melting point of 111° C., a melt index of 1.9 g/10 min, a density of 0.9230 g/cm³, and a Vicat softening point of 92° C. A commercially available low density polyethylene having these properties is sold under the name DOW POLYETHYLENE 503A by The Dow Chemical Company, Midland, Mich., U.S.A.

Layer 12 of film 10 may comprise a blend of 55.0% by weight of ethylene vinyl acetate copolymer:40.0% by weight of ionomer:5.0% by weight of an additive mixture comprising 80% by weight of an ethylene vinyl acetate copolymer (EVA):20.0% by weight slip agent. One example of an EVA which may be used in the present invention has a 12% by weight vinyl acetate content, a density of 0.93 g/cm³, a melt index of 0.35 g/10 min. a melting point of 95° C., a Vicat softening point of 82° C., and is sold under the trademark DUPONT™ ELVAX® 3135XZ by E.I. du Pont de Nemours and Company, Inc., Wilmington, Del., U.S.A. An example of an ionomer which may be used has a density of 0.94 g/cm³, a melt index of 1.3 g/10 min, a melting point of 98° C., a Vicat softening point of 75° C. and is sold under the trademark DUPONT™ SURLYN® 1601-2 by E.I. du Pont de Nemours and Company, Inc., Wilmington, Del., U.S.A. An example of a suitable slip agent for use in the additive mixture is erucamide which is a primary amide prepared by amidation of erucic acid.

### Example 2

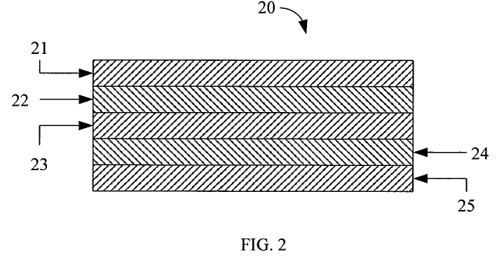

Referring to FIG. 2, Example 2 is illustrated by film 20 and represents one example of a five-layer embodiment of the present invention. Film 20 is prepared by a bubble coextrusion method as described herein. As depicted, film 20 is a palindromic film which has the following film configuration, layer composition and layer thickness (represented in brackets [ ] as percent thickness relative to the overall thickness of the film) as illustrated in Table 2:

TABLE 2
Film 20

| Layer No./Type | Layer Composition |
|---|---|
| 21 Outer-film Abuse | ULDPE:LDPE:additives [12.5%] |
| 22 Intermediate Tie | ULDPE:LDPE [12.5%] |
| 23 Core | EVA:ionomer:slip agent [50.0%] |
| 24 Intermediate Tie | ULDPE:LDPE [12.5%] |
| 25 Outer-film Sealant | ULDPE:LDPE:additives [12.5%] |

As shown in FIG. 2, first layer 21 is a first outer-film layer and may serve as an abuse-resistant layer, a second layer 22 is an intermediate layer and functions as a tie layer to bond first layer 21 to third layer 23, a third layer 23 is a core layer, a fourth layer 24 is an intermediate layer and functions as a tie layer to bond third layer 23 to fifth layer 25, and fifth layer 25 which is a second outer-film layer and may function as a sealant layer.

Layers 21 and 25 of film 20 each comprise a blend of 68.0% by weight of ultra low density polyethylene:21.5% by weight of low density polyethylene: 10.5% by weight of additives. The ultra low density polyethylene and low density polyethylene are identical to those described hereinabove for layers 11 and 13, respectively, of film 10.

Layer 23 includes a blend of 55.0% by weight of EVA:40.0% by weight of ionomer:5.0% by weight of an additive mixture comprising 80% by weight of an EVA:20.0% by weight slip agent. The EVA, ionomer and slip mixture used in layer 23 are identical to those materials described hereinabove for layer 12 of film 10.

Layers 22 and 24 of film 20 each comprise a blend of 75.0% by weight ULDPE:25.0% by weight LDPE. The ULDPE is an ethylene/octane polyethylene copolymer having a melting point of 123° C., a melt index of 1.0 g/10 min, a density of 0.9120 g/cm³, and a Vicat softening point of 93° C. An example of a commercially available ethylene/octene polyethylene copolymer which exhibits the desired characteristics as described above is sold under the trademark ATTANE® 4201G by The Dow Chemical Company, Midland, Mich., U.S.A. The LDPE has a melting point of 111° C., a melt index of 1.9 g/10 min, a density of 0.9230 g/cm³, and a Vicat softening point of 92° C. A commercially available low density polyethylene having these properties is sold under the name DOW POLYETHYLENE 503A by The Dow Chemical Company, Midland, Mich., U.S.A. The resulting film has a shrink tension of 300 psi and a clarity of greater than 90%. Film 20 has a total thickness of approximately 0.60 mil.

It is contemplated that variations of the invention may be made by substituting LLDPE for ULDPE, e.g., using commercially available ethylene octene-1 linear low density polyethylene having a density of about 0.92 g/cm³, a melt index of 0.8 to 1 dg/min, melting point of 120 to 123° C., and M_{w}/Mₙ>3.

### Comparative Example 3

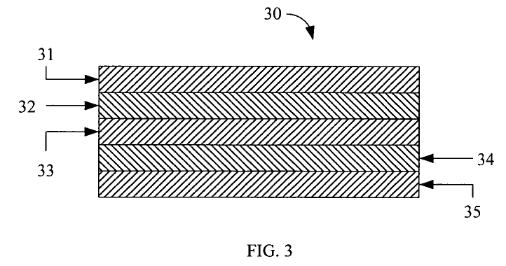

Turning now to FIG. 3, Comparative Example 3 is illustrated by film 30 and is prepared in the same manner as film 20. Film 30 is also a five layer palindromic structure which has the following film configuration, layer composition and layer thickness (represented in brackets [ ] as percent thickness relative to the overall thickness of the film) as illustrated in Table 3:

TABLE 3
Film 30

| Layer No./Type | Layer Composition |
|---|---|
| 31 Outer-film Abuse | ULDPE:LDPE:additives [12.4%] |
| 32 Intermediate Tie | ULDPE:LDPE [12.3%] |
| 33 Core | ionomer:slip agent [50.6%] |
| 34 Intermediate Tie | ULDPE:LDPE [12.3%] |
| 35 Outer-film Sealant | ULDPE:LDPE:additives [12.4%] |

As shown in FIG. 3, first layer 31 is a first outer-film layer and may serve as an abuse-resistant layer, a second layer 32 is an intermediate layer and functions as a tie layer to bond first layer 31 to third layer 33, a third layer 33 is a core layer, a fourth layer 34 is an intermediate layer and functions as a tie layer to bond third layer 33 to fifth layer 35, and fifth layer 35 which is a second outer-film layer and may function as a sealant layer.

Layers 31 and 35 of film 30 each comprise a blend of 67.0% by weight of ultra low density polyethylene:21.5% by weight of low density polyethylene: 11.5% by weight of additives. The ultra low density polyethylene and low density polyethylene are identical to those described hereinabove for layers 11 and 13, respectively, of film 10.

Layer 33 includes a blend of 95.0% by weight of ionomer:5.0% by weight of an additive mixture comprising 80% by weight of an EVA:20.0% by weight slip agent. The ionomer and slip mixture used in layer 33 are identical to those materials described hereinabove for layer 12 of film 10.

Layers 32 and 34 of film 30 each comprise a blend of 75.0% by weight ULDPE:25.0% by weight LDPE. The ULDPE and LDPE used in layers 32 and 34 are identical to those materials described hereinabove for layers 22 and 24 of film 20. Film 30 has a total thickness of approximately 0.63 mil.

The films from Example 2 and Comparative Example 3 were tested for coefficient of friction at least 24 h after production and the results were compared. Coefficient of friction is used to determine the kinetic (moving) and/or static (starting) resistance of one surface being dragged across another and determined according to ASTM D-1894 test method. In the test method, individual 2.5 in square specimens along with a rectangular 5 in by 10 in second surface are cut from each example. Each specimen was attached to a 200 g sled. The sled is pulled across a second surface at a speed of 150 mm/minute. The force to maintain motion (kinetic) is measured. The kinetic coefficient of friction is equal to the average force reading obtained during uniform sliding of the surfaces divided by the sled weight. The measurement results of the kinetic coefficient of friction for both examples are illustrated in Table 4.

TABLE 4
Physical and Optical Properties

| | | | | Kinetic | |
|---|---|---|---|---|---|
| | | | Heat | Coefficient | |
| | | | Shrinkage @ | of Friction | |
| | Haze | Gloss | 100° C. | Inside | Outside |
| Example 2 | <4% | >100% | 30% | 0.087 | 0.083 |
| Comparative | <4% | >100% | 36% | 0.513 | 0.520 |
| Example 3 | | | | | |

As evidenced by the data in Table 4, the films of this invention, i.e., films having core layers comprising a combination of at least 50% by weight EVA and ionomer, have a substantially lower coefficient of friction than non-EVA containing core layer films. This data bears out the superiority of the films of this invention in reducing the coefficient of friction while maintaining good optical characteristics and heat shrinkage.

Variations of the above embodiments may utilize the wide selection of polymers, films, additives, attributes and parameters disclosed herein as will be recognized by one skilled in the art in view of the present teaching

Multilayer films of 3, 4, 5, 6, 7, 8, 9 or more layers are contemplated. The inventive multilayer films may include additional layers or polymers to add or modify various properties of the desired film such as heat sealability, interlayer adhesion, food surface adhesion, shrink force, wrinkle resistance, puncture resistance, printability, toughness, gas or water barrier properties, abrasion resistance and other optical properties such as freedom from lines, streaks or gels. These layers may be formed by any suitable method including coextrusion, extrusion coating and lamination.

Unless otherwise noted, the physical properties and performance characteristics reported herein were measured by test procedures similar to the following methods. The following ASTM test procedures are incorporated herein by reference in their entireties.

| | |
|---|---|
| Density | ASTM D-1505 |
| Melt Index | ASTM D-1238 |
| Melting Point | ASTM D-3417 |
| Vicat Softening Point | ASTM D-1525 |
| Unrestrained Linear Thermal Shrinkage | ASTM D-2732-96 |
| Coefficient of Friction | ASTM D-1894 |
| Shrink Tension | ASTM D-2838-02 |
| Haze | ASTM D-1003 |
| Gloss (45°) | ASTM D-2457 |
| | or ASTM D-523 |
| Clarity | ASTM D-1746 |

The above examples are illustrative only, and should not be interpreted as limiting since further modifications of the disclosed embodiments will be apparent to those skilled in the art in view of this teaching. All such modifications are deemed to be within the scope of the invention disclosed herein.

What is claimed is:

1. A biaxially-oriented multilayer thermoplastic film comprising:
a) two outer-film layers each comprising a polyolefin resin;
b) a core layer comprising a blend of at least 50% by weight relative to said core layer of a first material comprising an ethylene unsaturated-ester copolymer and a second material selected from the group consisting of ionomers, ethylene/acid copolymers and terpolymers, and blends thereof; and
c) wherein said film has an unrestrained linear thermal shrinkage value of at least 20% in both machine and transverse directions at 100° C. as measured in accordance with ASTM D-2732-96 test method, and a coefficient of friction of less than 0.5 as measured in accordance with ASTM D-1894 test method.

2. The film of claim 1, wherein said ethylene unsaturated-ester copolymer is selected from the group consisting of ethylene vinyl acetate copolymer, ethylene butyl acetate copolymer, ethylene methyl acetate copolymer, ethylene ethyl acetate copolymer, and blends thereof.

3. The film of claim 1, wherein said outer-film layers each comprise a material selected from the group consisting of homopolymer and copolymers of polyethylene, polypropylene and blends thereof.

3. The film of claim 1, wherein said outer-film layers each comprise at least a low-density polyethylene copolymer.

5. The film of claim 1, wherein said outer-film layers each comprise a blend of a linear low-density polyethylene, a very low-density polyethylene or an ultra low-density polyethylene copolymer and a low-density polyethylene.

6. The film of claim 1, wherein said core layer comprises at least 20% by weight relative to said core layer of a second material selected from the group consisting of ionomers, ethylene/acid copolymers and terpolymers, and blends thereof.

7. The film of claim 1, wherein said core layer comprises at least an acid neutralized salt of ethylene/methacrylic acid copolymer.

8. The film of claim 1, wherein said core layer has a relative thickness of between 50 to 95% of the total thickness of said film.

9. The film of claim 1, wherein said film is coextruded.

10. The film of claim 1, wherein said film has a shrink tension of 300 psi or less at 100° C. as measured in accordance with ASTM D-2838-02 test method.

11. The film of claim 1, wherein said film has a clarity value of at least 85% as measured in accordance with ASTM D-1746 test method and a haze value of less than 4% as measured in accordance with ASTM D-1003 test method.

12. The film of claim 1, wherein said film has a coefficient of friction of less than 0.25 as measured in accordance with ASTM D-1894 test method.

13. The film of claim 1, wherein said film has a coefficient of friction of less than 0.10 as measured in accordance with ASTM D-1894 test method.

14. The film of claim 1, wherein said film has an unrestrained linear thermal shrinkage value of at least 30% in both machine and transverse directions at 100° C. as measured in accordance with ASTM D-2732-96 test method.

15. The film of claim 1, wherein said core layer further comprises between 0.2 to 1.0% by weight of a slip agent.

16. The film of claim 1, wherein said core layer further comprises between 0.2 to 1.0% by weight of an amide slip agent.

17. The film of claim 1, wherein said film is crosslinked.

18. The film of claim 1, wherein said film is adapted to form a packaging article.

19. A biaxially-oriented multilayer thermoplastic film comprising:
a) two outer-film layers each comprising a blend of a linear low-density polyethylene, a very low-density polyethylene or an ultra low-density polyethylene copolymer and a low-density polyethylene;
b) a core layer comprising a blend of at least 50% by weight relative to said core layer of a first material selected from the group consisting of ethylene vinyl acetate copolymer, ethylene butyl acetate copolymer, ethylene methyl acetate copolymer, ethylene ethyl acetate copolymer, and blends thereof, and a second material selected from the group consisting of ionomers, ethylene/acid copolymers and terpolymers, and blends thereof, and at least 20% by weight relative to said core layer of a second material selected from the group consisting of ionomers, ethylene/acid copolymers and terpolymers, and blends thereof; and
c) wherein said film has an unrestrained linear thermal shrinkage value of at least 20% in both machine and transverse directions at 100° C. as measured in accordance with ASTM D-2732-96 test method, and a coefficient of friction of less than 0.5 as measured in accordance with ASTM D-1894 test method.

20. The film of claim 19, wherein said core layer comprises at least an acid neutralized salt of ethylene/methacrylic acid copolymer.

21. The film of claim 19, wherein said core layer has a relative thickness of between 50 to 95% of the total thickness of said film.

22. The film of claim 19, wherein said film is coextruded by a blown film coextrusion method.

23. The film of claim 19, wherein said film has a shrink tension of 300 psi or less at 100° C. as measured in accordance with ASTM D-2838-02 test method.

24. The film of claim 19, wherein said film has a clarity value of at least 85% as measured in accordance with ASTM D-1746 test method and a haze value of less than 4% as measured in accordance with ASTM D-1003 test method.

25. The film of claim 19, wherein said film has a coefficient of friction of less than 0.25 as measured in accordance with ASTM D-1894 test method.

26. The film of claim 19, wherein said film has a coefficient of friction of less than 0.10 as measured in accordance with ASTM D-1894 test method.

27. The film of claim 19, wherein said film has an unrestrained linear thermal shrinkage value of at least 30% in the both machine and transverse directions at 100° C. as measured in accordance with ASTM D-2732-96 test method.

28. The film of claim 19, wherein said core layer further comprises between 0.2 to 1.0% by weight of a slip agent.

29. The film of claim 19, wherein said core layer further comprises between 0.2 to 1.0% by weight of an amide slip agent.

30. The film of claim 19, wherein said film is adapted to form a packaging article.

31. A biaxially-oriented multilayer thermoplastic film comprising:
a) a first and a second outer-film layer each comprising a blend of a linear low-density polyethylene, a very low-density polyethylene or an ultra low-density polyethylene copolymer and a low-density polyethylene;
b) a core layer disposed between said first and second outer-film layers and comprising a blend of at least 50% by weight relative to said core layer of a first material selected from the group consisting of ethylene vinyl acetate copolymer, ethylene butyl acetate copolymer, ethylene methyl acetate copolymer, ethylene ethyl acetate copolymer, and blends thereof, and a second material selected from the group consisting of ionomers, ethylene/acid copolymers and terpolymers, and blends thereof, at least 20% by weight relative to said core layer of a second material selected from the group consisting of ionomers, ethylene/acid copolymers and terpolymers, and blends thereof, and between 0.2 to 1.0% by weight of an amide slip agent; wherein said core layer has a thickness of at least 50% of the total thickness of said film;
c) a first intermediate layer positioned between said first outer-film layer and said core layer, and a second intermediate layer positioned between said second outer-film layer and said core layer; wherein each of said intermediated layers comprise a polyolefin; and
d) wherein said film has an unrestrained linear thermal shrinkage value of at least 30% in both machine and transverse directions at 100° C. as measured in accordance with ASTM D-2732-96 test method, and a coefficient of friction of less than 0.25 as measured in accordance with ASTM D-1894 test method.

32. The film of claim 31, wherein said film has a coefficient of friction of less than 0.10 as measured in accordance with ASTM D-1894 test method.

33. The film of claim 31, wherein said film is adapted to form a packaging article.
